(19) United States
(12) Patent Application Publication
(10) Pub. No.: US 2002/0171388 A1
(43) Pub. Date: Nov. 21, 2002

(54) Apparatus for driving three-phase half-wave drive brushless motor

(76) Inventor: Kunio Seki, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 10/131,283

(22) Filed: Apr. 23, 2002

(30) Foreign Application Priority Data
May 18, 2001 (JP) 2001-148615

(51) Int. Cl. H02P 1/24; H02P 1/42; H02P 3/18; H02P 5/28; H02P 7/36

(52) U.S. Cl. 318/727

(57) ABSTRACT

An apparatus for driving a three-phase half-wave drive brushless motor, which has a simple structure easily unaffected by a noise and so on and requiring no counter, no AD converter and so on, and which can exactly determine a stop position of a rotor to a stator of the motor, determine a phase stator winding from which a current-carrying is started, and correctly rotate the rotor in a desired direction when the motor is driven. The apparatus supplies a short pulse current to any two phase stator windings of three phase stator windings so that the rotor is not driven when the rotor stops, and determines the stop position of the rotor on the basis of a difference of kickback times caused by a difference of inductances changing subtly according to a difference of the stop position of the rotor.

### BACKGROUND OF THE INVENTION

1. Field of the Invention

The invention relates to a controlling technique for driving a three-phase half-wave drive brushless motor, and in particular to an effective technique in a detecting system of a stop position of a rotor and a starting system when the rotor starts rotating. For example, the invention relates to an effective technique in a main motor of an apparatus such as a portable AV (audiovisual) apparatus and so on, which requires a low manufacturing cost.

2. Description of Related Art

Conventionally, a system for driving a three-phase direct-current brushless motor has a full-wave driving system for supplying a current from one of three phase stator windings to the other two phase stator windings and driving the brushless motor, and a half-wave driving system for supplying a current from a center tap to which a terminal of each of three phase stator windings is commonly connected and which is connected to a terminal of a power supply, to only any one of the phase stator windings.

Because the full-wave driving system can control the brushless motor to drive with high accuracy, the full-wave driving system is used for driving a spindle motor for rotating a storage medium of a disc type storage apparatus such as a hard disc apparatus.

On the other hand, although the half-wave driving system cannot control the brushless motor to drive with high accuracy as well as the full-wave driving system, the half-wave driving system is effective in reducing a manufacturing cost thereof because the half-wave driving system requires a simple circuit and a small number of elements.

Further, a direct-current brushless motor has not only the above-described three-phase direct-current brushless motor but also a two-phase direct-current brushless motor. A system for driving the two-phase direct-current brushless motor has a half-wave driving system as well as the three-phase direct-current brushless motor. However, because the three-phase half-wave drive direct-current brushless motor dose not have a torque dip as well as the two-phase half-wave drive direct-current brushless motor, the three-phase half-wave drive direct-current brushless motor is effective in more easily changing and controlling a rotation direction than the two-phase half-wave drive direct-current brushless motor.

FIG. 1 is a schematic view showing a construction of a three-phase twelve-pole brushless motor according to an earlier development.

In FIG. 1, the reference numeral “1” denotes a rotor magnet, “2” denotes a stator core, “3a”, “3b” and “3c” denote first-phase windings (for example, U-phase windings), “4a”, “4b” and “4c” denote second-phase windings (for example, V-phase windings), and “5a”, “5b” and “5c” denote third-phase windings (for example, W-phase windings). Because the above-described three-phase brushless motor is high efficient for driving and has a small torque ripple, the three-phase brushless motor is frequently applied as a spindle motor of various types of disc apparatuses incorporated in a personal computer, a main motor of another type of OA (office automation) apparatus and AV (audiovisual) apparatus, and so on.

Some of the above-described three-phase brushless motor are sensor types comprising a position detecting element such as a hall element and so on, for detecting a position of a rotor to determine a current-carrying phase, and others are so-called sensorless types comprising not any position detecting element. As compared between the two types, because the sensorless type is superior to the sensor type in a manufacture, a manufacturing cost and a size, in recent years, a demand for the sensorless type has increased.

Further, in order to drive the sensorless type of three-phase motor, a special technique is required, and the following two types are considered as the special technique.

The first type is a method of generating a revolving field in a driving circuit regardless of a stop position of the rotor, getting a back electromagnetic force of a non current-carrying phase when the rotor starts rotating according to the revolving field, and keeping the rotor rotating with changing the current-carrying phase. According to the first type of method, because the excitation always starts from the predetermined phase in a preprogrammed sequence regardless of the stop position of the rotor when the rotor is driven, there occurs a motion which is called a back motion wherein the rotor rotates in an opposite direction to a desired direction, in a 50 percent probability. As a result, because the back motion may not only have an effect on a driving time of the motor, but also do fatally damage the motor itself or another structure as that depends on the uses thereof, it is necessary to prevent the back motion from occurring as much as possible.

The second type is a method of searching the stop portion of the rotor when the rotor is driven, and determining the phase from which the excitation starts on the basis of the stop portion. According to method, it is possible to prevent the back motion from occurring.

The method of detecting the stop position of the rotor of the bruchless motor without using the position detecting sensor as a hall sensor is disclosed in, for example, Japanese Patent Application Publication (Unexamined) No. Tokukai-syo 63-69489 (corresponding to the U.S. Pat. No. 4,876,491) or Japanese Patent Application Publication (Examined) No. Tokuko-hei 8-13196 (corresponding to the U.S. Pat. No. 5,001,405).

According to all the method, by using a characteristic that is an inductance of a stator winding changes subtly according to the stop position of the rotor, a pulse current is supplied to stator windings in order for a short time while the rotor dose not react, and the stop position of the rotor is determined on the basis of a change of a rise time constant of the current supplied to the stator winding.

However, because the change of the rise time constant of the current is quite little, and the current can not be read directly, it is necessary to transform from the current to a voltage once. However, because the transformed voltage is a small value from tens of mV to hundreds of mV, the voltage has a fault in being easily affected by a noise. Further, because various circuits such as a counter for measuring the time, an AD converter or a comparator for comparing voltages, and so on are required to compare the changes of the rise time constants of the current, there occurs an inconvenient state wherein a size of the circuit is expanded.

### SUMMARY OF THE INVENTION

The present invention was developed in view of the above-described problems.

It is an object of the present invention to provide a controlling technique for driving a three-phase half-wave brushless motor, which has a simple structure easily unaffected by a noise and so on and requiring no counter, no AD converter and so on, and which can exactly determine a stop position of a rotor to a stator of the motor, determine a winding from which a current-carrying is started, and correctly rotate the rotor in a desired direction when the motor is driven.

The present invention is aimed at a width difference of kickback voltages generated when inductances are turned off, that is a difference of kickback times, according to the stop position of the rotor. Therefore, according to the present invention, a length of kickback times is determined, and thereby the stop position of the rotor is determined.

That is, according to the present invention, a short pulse current is supplied to any two stator windings of three stator windings so that the rotor is not driven when the rotor stops. Thereafter, when the stop position of the rotor is determined on the basis of a difference of kickback times caused by a difference of inductances of the two stator windings changing subtly according to a difference of the stop position of the rotor, the phase from which the current-carrying is started is determined on the basis of the determined stop position of the rotor.

More specifically, in accordance with an aspect of the present invention, an apparatus for driving a three-phase half-wave drive brushless motor comprising a rotor and three phase stator windings having a terminal connected to a power supply voltage terminal, by changing a current supplied to each of the phase stator windings, comprises: an output circuit for supplying the current to each of the phase stator windings selectively; a back electromagnetic force detector for detecting a back electromagnetic force induced in one to which the current is not supplied of the phase stator windings, and outputting a detection signal; a control logic for controlling the output circuit on the basis of the detection signal outputted from the back electromagnetic force detector; and a stop position detector for comparing widths of kickback voltages generated in the phase stator windings with each other, after the current is supplied to each of the phase stator windings for a predetermined time while the rotor does not react and tuned off, and detecting a stop position of the rotor; wherein the control logic controls the output circuit so as to supply the current to any one of the phase stator windings on the basis of the stop position of the rotor detected by the stop position detector, to drive the three-phase half-wave drive brushless motor.

According to the apparatus of the aspect of the present invention, it is possible to detect the stop position of the rotor to a stator of the three-phase half-wave drive bushless motor, determine the phase stator winding to which the current is supplied first, and rotate the three-phase half-wave drive brushless motor in a desired direction, without using a hall element and providing such a circuit as a counter, an AD converter and so on therein.

Preferably, in the apparatus for driving the three-phase half-wave drive brushless motor, of the aspect of the present invention, the control logic controls the output circuit so as to supply the current to any two phase stator windings of the three phase stator windings at the same time for a predetermined time, and the stop position detector detects the stop position of the rotor on the basis of a time difference of kickback voltages generated in the two phase stator windings to which the current is supplied, after the current is cut off.

Accordingly, when kickback voltages are generated in the two phase stator windings at the same time, and compared with each other, it is possible to detect the stop position of the rotor to the stator in a short time. That is, it is possible to be thought that the current is supplied to the two phase stator windings separately, and kickback times generated in the two phase stator windings respectively are compared with each other. However, because the current is supplied to the two phase stator windings at the same time, it is possible to compare the lengths of the kickback times efficiently.

Preferably, in the apparatus for driving the three-phase half-wave drive brushless motor, as described above, the stop position detector detects the stop position of the rotor on the basis of the time difference of kickback voltages generated in each of different combinations of the two phase stator windings to which the current is supplied for the predetermined time, after the current is cut off.

Accordingly, it is possible to detect the stop position of the rotor exactly. As a result, because the phase stator winding to which the current is supplied first is determined on the basis of the detected stop position, it is possible to rotate the rotor in a desired direction quickly.

Preferably, in the apparatus for driving the three-phase half-wave drive brushless motor, as described above, the predetermined time is longer than a time constant of each of the phase stator windings, and shorter than a reaction time of the rotor.

Accordingly, it is possible to prevent the rotor from shifting, and detect the stop position of the rotor more exactly.

Further, in accordance with another aspect of the present invention, a method for driving a three-phase half-wave drive brushless motor comprising a rotor and three phase stator windings having a terminal connected to a power supply voltage terminal, by changing a current supplied to each of the phase stator windings, comprises: supplying the current to any two phase stator windings of the three phase stator windings for a predetermined time while the rotor dose not react; comparing widths of kickback voltages generated in the two phase stator windings with each other, and detecting the stop position of the rotor; determining any only one phase stator winding of the three phase stator windings to be a first current-carrying phase stator winding, when determining that the rotor stops within a range of an electric angle at which the only one phase stator winding has a negative torque constant (or a positive torque constant) on the basis of the stop position of the rotor; and determining any two phase stator windings of the three phase stator windings to be first current-carrying phase stator windings so that a first current-carrying time of one of the two phase stator windings is shorter than a second current-carrying time of another of the two phase stator windings, when determining that the rotor stops within a range of an electric angle at which the two phase stator windings have negative torque constants (or positive torque constants) on the basis of the stop position of the rotor.

According to the method of another aspect of the present invention, it is possible to generate the biggest torque and drive the three-phase half-wave drive brushless motor, even if the rotor stops within the range of any electric angle.

Preferably, in the method of another aspect of the present invention, the first current-carrying time which is shorter than the second current-carrying time is 1/4-1/2 of a time required for the rotor to steadily rotate at the electric angle of 60 degrees.

Accordingly, it is possible to prevent that the torque generated in another stator winding to which the current is supplied prevents the torque generated in the desired stator winding to which the current is supplied from driving the three-phase half-wave drive brushless motor.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a schematic view showing an exemplary construction of a three-phase twelve-pole half-wave drive brushless motor;

FIG. 2 is a block diagram showing an exemplary construction of an apparatus for driving a three-phase half-wave drive brushless motor according to the present invention;

FIGS. 3A, 3B, 3C, 3D, 3E and 3F are schematic views for explaining a principle of detecting a stop position of a rotor of the three-phase half-wave drive brushless motor according to the present invention;

FIGS. 4A, 4B and 4C are wave form charts showing a relationship between the stop position of the rotor and a kickback time difference of any one of three phases and another one of the three phases, of the three-phase half-wave drive brushless motor;

FIGS. 5A, 5B, 5C, 5D and 5E are wave form charts showing a relationship between the stop position of the rotor and the kickback time difference of all two phases of the three phases, of the three-phase half-wave drive brushless motor;

FIGS. 6A, 6B, 6C, 6D, 6E, 6F and 6G are timing charts of detecting the stop position of the rotor of the three-phase half-wave drive brushless motor;

FIGS. 7A and 7B are flow charts showing a processing of controlling the three-phase half-wave drive brushless motor to which the present invention is applied when the motor is driven; and

FIG. 8 is a block diagram showing a specific construction of a kickback detector 12 and a back electromagnetic force detector 13.

### PREFERRED EMBODIMENTS OF THE INVENTION

Hereinafter, a preferred embodiment of the present invention will be explained with reference to figures, as follows.

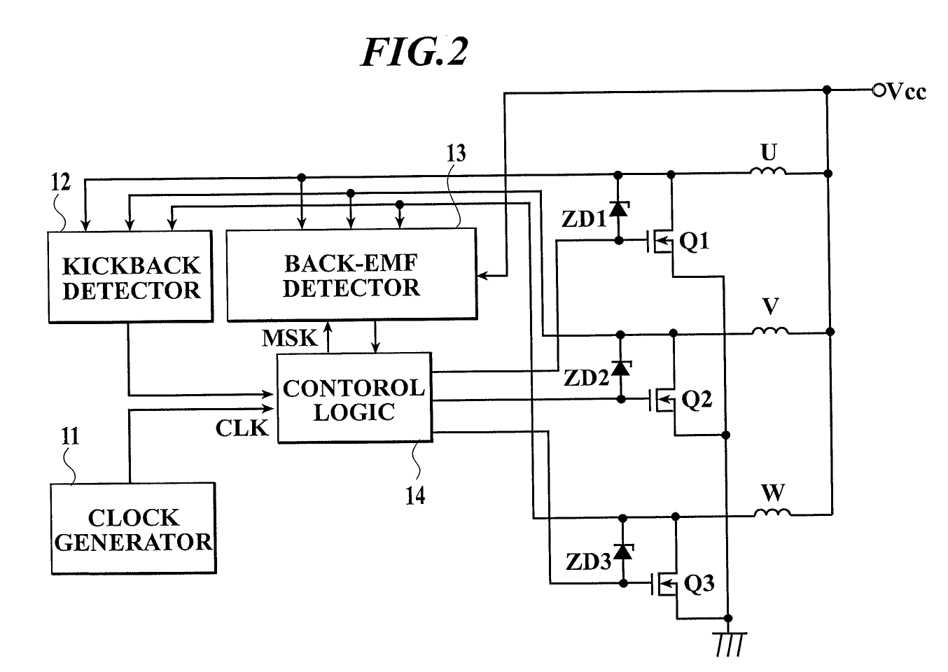

FIG. 2 is a block diagram showing an exemplary construction of a circuit for driving a three-phase half-wave drive brushless motor according to the present invention.

The reference characters “U”, “V” and “W” denote stator windings comprising windings which are wound on a core of a stator, “Q1”, “Q2” and “Q3” denote output transistors for supplying a drive current to the stator windings U, V and W, and “ZD1”, “ZD2” and “ZD3” denote zener diodes for clamping output voltages. Further, in the circuit for driving the three-phase half-wave drive brushless motor, a center tap to which one terminal of each of the stator windings U, V and W is commonly connected is connected to a voltage terminal Vcc of a power supply.

Further, in FIG. 2, the reference numeral “11” denotes a clock generator for generating a necessary clock signal for the circuit to drive, “12” denotes a kickback detector for detecting a kickback voltage generated when the stator windings U, V and W are turned off, to determine a stop position of a rotor magnet, “13” denotes a back-EMF detector (a back electromagnetic force detector) for detecting a position of the rotor magnet rotating on the basis of a zero-cross point of a back electromagnetic force of the stator winding, and “14” denotes a control logic for observing and controlling the whole circuit.

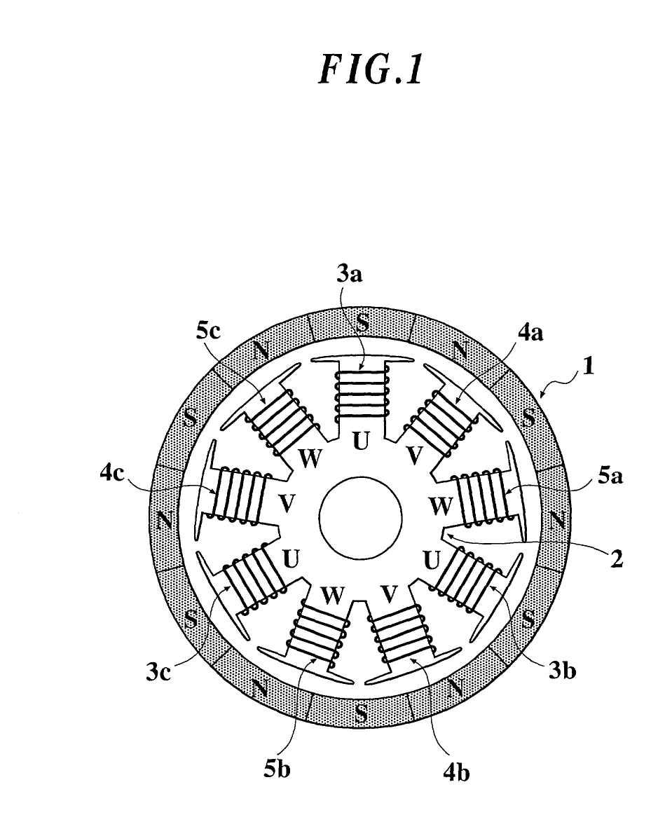

Further, for example, in order to detect a rise of an unusual temperature of a chip in case the circuit shown in FIG. 1 is mounted as a monolithic integrated circuit, a temperature detector besides the above-described circuits may be provided as the occasion may demand.

Hereinafter, the motion of the three-phase half-wave drive brushless motor driven by the circuit having the above-described construction, according to the embodiment will be explained simply.

First, the output transistors Q2 and Q3 are turned on at the same time only for a short time. Therefore, the stop position of the rotor is determined on the basis of the kickback time after the output transistors Q2 and Q3 are turned off, that is, the time passing while the energy stored in the stator windings V and W while the output transistors Q2 and Q3 are turned on, flows to a power supply back.

That is, in the circuit shown in FIG. 2, when the output transistors Q2 and Q3 are turned on at the same time, the current is supplied to the V-phase stator winding and the W-phase stator winding from the power supply. When the output transistors Q2 and Q3 are turned off at the same time in the above-described state, the current keeps flowing to each stator winding.

Accordingly, the V-phase output voltage and the W-phase output voltage which have been almost ground potentials rise to the zener voltage in one go. The state is kept until all the energy stored in each stator winding is used. Herein, if the direct current resistances are not almost uneven between the stator windings, the kickback times of the V-phase stator winding and the W-phase stator winding are determined according to the inductances thereof. Therefore, the bigger the inductance is, the longer the kickback time is.

Next, the output transistors Q3 and Q1 are turned on at the same time only for a short time. After the output transistors Q3 and Q1 are turned off, the kickback times of the W-phase stator winding and the U-phase stator winding are compared with each other. Further, thereafter, the output transistors Q1 and Q2 are turned on at the same time only for a short time. After the output transistors Q1 and Q2 are turned off, the kickback times of the U-phase stator winding and the V-phase stator winding are compared with each other. Therefore, it is possible to determine the stop position of the rotor for every about electric angle of 60 degrees by comparing the kickback times at three times.

When the stop position of the rotor can be determined according to the above-described method, the current is supplied to the phase stator winding which is in the predetermined rotating direction. At the same time, the back-EMF detector 13 observes the back electromagnetic force which is generated in the non current-carrying phase. Then, when the back-EMF detector 13 detects a zero-cross of the back electromagnetic force in the predetermined rotating direction, the current-carrying phase is changed. At the same time, the control logic 14 outputs a mask signal to the back-EMF detector 13 in order to prevent the back-EMF detector 13 from detecting the kickback voltage by mistake.

As described above, because the current-carrying phase is changed even when the back-EMF detector 13 detects the zero-cross, it is possible to keep the rotor rotating.

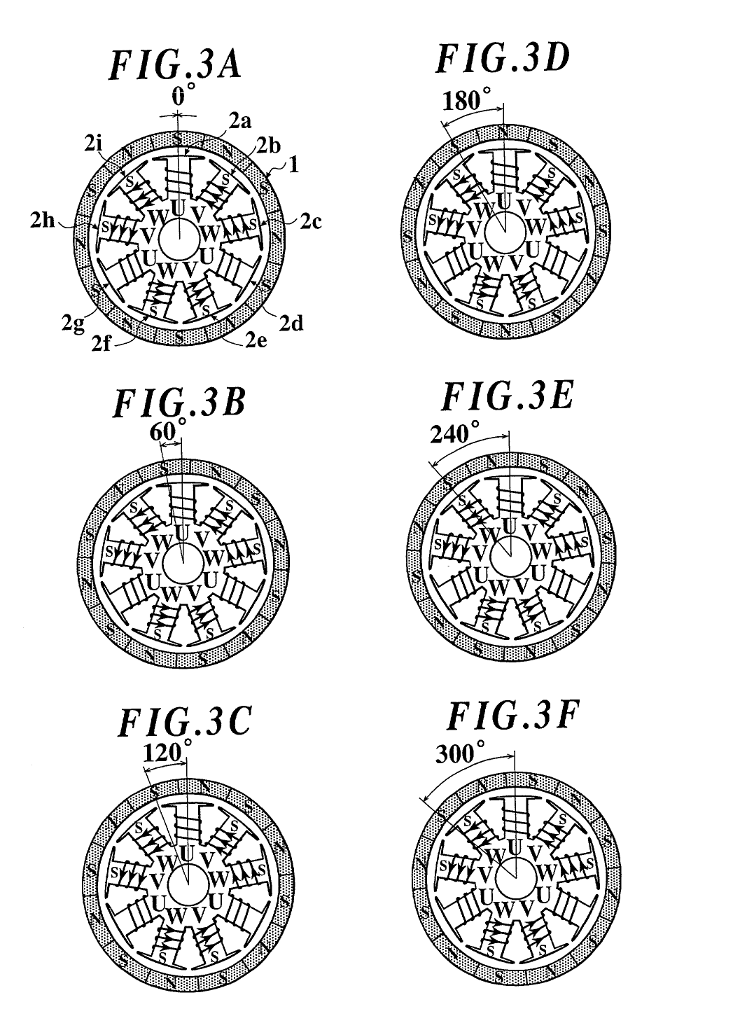

Next, the principle of detecting the stop position of the rotor in case the present invention is applied to the controlling circuit for driving the three-phase twelve-pole brushless motor will be explained with reference to FIGS. 3A to 3F.

FIGS. 3A to 3F are schematic views of the three-phase twelve-pole brushless motor. In FIGS. 3A to 3F, the reference numeral “1” denotes the rotor magnet, and “2a” to “2i” denote magnetic poles of the stator.

First, the state wherein the output transistors Q2 and Q3 are turned on in the circuit shown in FIG. 2 is thought out. In the state, the V-phase stator magnetic poles 2b, 2e and 2h and the W-phase stator magnetic poles 2c, 2f and 2i are magnetized to the same polarities as each other. For example, in case the current flows in each magnetic pole in the direction indicated by an arrow shown in FIG. 3A, the V-phase stator magnetic poles 2b, 2e and 2h and the W-phase stator magnetic poles 2c, 2f and 2i are magnetized to the S pole.

FIG. 3A shows the state wherein the S pole of the rotor magnet is right in front of each of the U-phase stator magnetic poles 2a, 2d and 2g, that is, the state wherein the electric angle is 0 degrees. Further, FIGS. 3B, 3C, 3D, 3E and 3F show the states wherein the position of the rotor magnet is rotated for every 60 degrees in a counterclockwise direction.

As shown in FIGS. 3A to 3F, even if the position of the rotor is changed and the current-carrying of the stator winding is not changed, the polarity of the stator magnetic pole is not changed.

In case the rotor and the stator are in the positional relationship shown in FIG. 3A, that is, the S pole of the rotor magnet is right in front of each of the U-phase stator magnetic poles and the electric angle is 0 degrees, about 2/3 of the magnetic flux generated from the N pole of the rotor and about 1/3 of the magnetic flux generated from the S pole of the rotor pass through each of the V-phase stator magnetic poles and the W-phase stator magnetic poles. Therefore, there does not occur the difference between the inductance of the V-phase stator winding and the inductance of the W-phase stator winding. Accordingly, when the output transistors Q2 and Q3 are turned off at the same time, there occurs the only difference between the kickback time of the V-phase stator winding and the kickback time of the W-phase stator winding within the limits of original unevenness of inductances and direct current resistances of two stator windings. Usually, the difference between the kickback times is within two percent.

In case the rotor and the stator are in the positional relationship shown in FIG. 3D, that is, the N pole of the rotor magnet is right in front of each of the U-phase stator magnetic poles and the electric angle is 180 degrees, about 2/3 of the magnetic flux generated from the S pole of the rotor and about 1/3 of the magnetic flux generated from the N pole of the rotor pass through each of the V-phase stator magnetic poles and the W-phase stator magnetic poles, in opposition to the case shown in FIG. 3A. Accordingly, there does not occur the difference between the kickback time of the V-phase stator winding and the kickback time of the W-phase stator winding.

In case the rotor and the stator are in the positional relationship shown in FIG. 3B, that is, the electric angle is 60 degrees, the N pole of the rotor magnet is right in front of each of the W-phase stator magnetic poles, and about 2/3 of the S pole of the rotor magnet and about 1/3 of the N pole of the rotor magnet are in front of each of the V-phase stator magnetic poles.

Therefore, in each of the W-phase stator magnetic poles, because the magnetic flux generated from the W-phase stator winding and the magnetic flux generated from the rotor are superimposed on each other, the W-phase stator magnetic pole becomes the magnetic saturation. Accordingly, the inductance of the W-phase stator winding decreases.

On the other hand, in each of the V-phase stator magnetic poles, because the S pole of the rotor has a greater affect on the V-phase stator winding, the magnetic flux generated from the V-phase stator winding and the magnetic flux generated from the rotor affect each other in the negative direction, and the V-phase stator magnetic pole becomes the opposite state to the magnetic saturation. Accordingly, the inductance of the V-phase stator winding increases.

As a result, when the output transistors Q2 and Q3 are turned off, the kickback time of the V-phase stator winding is longer than the kickback time of the W-phase stator winding.

In case the rotor and the stator are in the positional relationship shown in FIG. 3C, that is, the electric angle is 120 degrees, the S pole of the rotor magnet is right in front of each of the V-phase stator magnetic poles, and about 2/3 of the N pole of the rotor magnet and about 1/3 of the S pole of the rotor magnet are in front of each of the W-phase stator magnetic poles.

Therefore, as well as the case shown in FIG. 3B, the inductance of the W-phase stator winding decreases, and the inductance of the V-phase stator winding increases. As a result, when the output transistors Q2 and Q3 are turned off, the kickback time of the V-phase stator winding is longer than the kickback time of the W-phase stator winding.

In case the rotor and the stator are in the positional relationship shown in FIG. 3E, that is, the electric angle is 240 degrees, the S pole of the rotor magnet is right in front of each of the W-phase stator magnetic poles, and about 2/3 of the N pole of the rotor magnet and about 1/3 of the S pole of the rotor magnet are in front of each of the V-phase stator magnetic poles, in opposition to the case shown in FIG. 3B.

Therefore, in each of the W-phase stator magnetic poles, because the magnetic flux generated from the W-phase stator winding and the magnetic flux generated from the rotor affect each other in the negative direction, the W-phase stator magnetic pole becomes the opposite state to the magnetic saturation. Accordingly, the inductance of the W-phase stator winding increases.

On the other hand, in each of the V-phase stator magnetic poles, because the N pole of the rotor has a greater affect on the V-phase stator winding, the magnetic flux generated from the V-phase stator winding and the magnetic flux generated from the rotor are superimposed on each other, and the V-phase stator magnetic pole becomes the magnetic saturation. Accordingly, the inductance of the V-phase stator winding decreases.

As a result, when the output transistors Q2 and Q3 are turned off, the kickback time of the V-phase stator winding is shorter than the kickback time of the W-phase stator winding.

In case the rotor and the stator are in the positional relationship shown in FIG. 3F, that is, the electric angle is 300 degrees, the N pole of the rotor magnet is right in front of each of the V-phase stator magnetic poles, and about 2/3 of the S pole of the rotor magnet and about 1/3 of the N pole of the rotor magnet are in front of each of the W-phase stator magnetic poles, in opposition to the case shown in FIG. 3C.

Therefore, as well as the case shown in FIG. 3E, the inductance of the W-phase stator winding increases, and the inductance of the V-phase stator winding decreases. As a result, when the output transistors Q2 and Q3 are turned off, the kickback time of the V-phase stator winding is shorter than the kickback time of the W-phase stator winding.

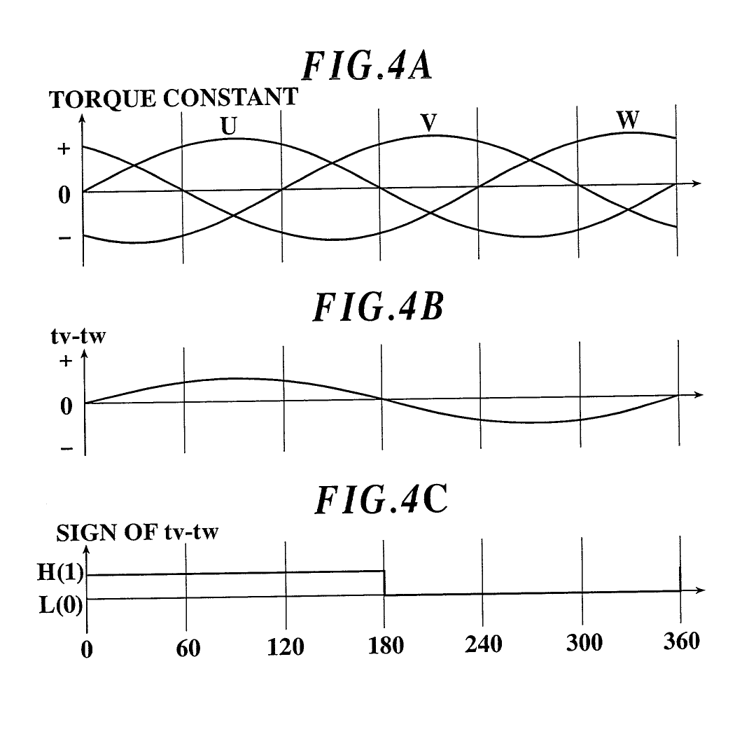

FIGS. 4A to 4C are wave form charts showing results of an observation on the kickback time difference (tv−tw) between the V-phase and the W-phase when the output transistors Q2 and Q3 are turned on, the current flows to the V-phase and the W-phase only for a short time, and the output transistors Q2 and Q3 are turned off, according as the stop position of the rotor is changed from the electric angle of 0 degrees to 360 degrees.

FIG. 4A is a wave form chart showing a torque constant curve generated when the current flows through each stator winding. In case of the half-wave driving system, the current is supplied to only the stator winding having a positive torque constant or a negative torque constant. FIG. 4B is a wave form chart showing the kickback time difference between the V-phase and the W-phase, that is, the result obtained by subtracting the W-phase kickback time from the V-phase kickback time. FIG. 4C is a wave form chart showing the value obtained by expressing the kickback time difference in the binary system so as to indicate “H(1)” when the V-phase kickback time is longer than the W-phase kickback time and “L(0)” when the V-phase kickback time is shorter than the W-phase kickback time.

The value expressed in the binary system can be easily generated by, for example, a D type flip flop circuit driving according to a kickback pulse signal generated by the kickback detector 12.

In FIGS. 4A to 4C, it is shown that the V-phase kickback time is longer than the W-phase kickback time from the electric angle of 0 degrees to 180 degrees, and the W-phase kickback time is longer than the V-phase kickback time from the electric of angle 180 degrees to 360 degrees. Further, it is understood that the wave form showing the kickback time difference between the V-phase and the W-phase has the same phase as the wave form showing the torque constant of the U-phase state winding.

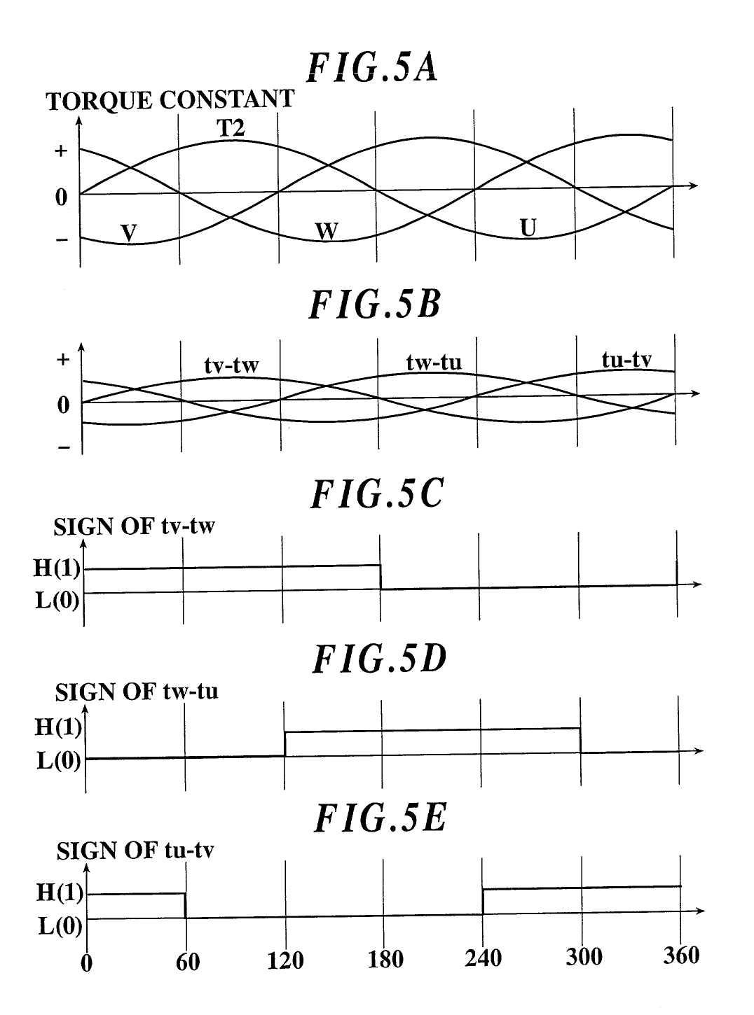

FIGS. 5A to 5E are wave form charts showing results of an observation on the kickback time difference between the W-phase and the U-phase generated when the output transistors Q3 and Q1 are turned on and after turned off, at the same time, and the current flows to the W-phase and the U-phase only for a short time, and results of an observation on the kickback time difference between the U-phase and the V-phase generated when the output transistors Q1 and Q2 are turned on and after turned off, at the same time, besides the results shown in FIGS. 4A to 4C.

As shown in FIGS. 5A to 5E, when the output transistors are turned on and turned off in the different phase combination of stator windings from each other at three times, it is understood that three binary data concerning the stop position of the rotor can be obtained. As a result, it is possible to determine the stop position of the rotor for every electric angle of 60 degrees on the basis of the obtained three binary data.

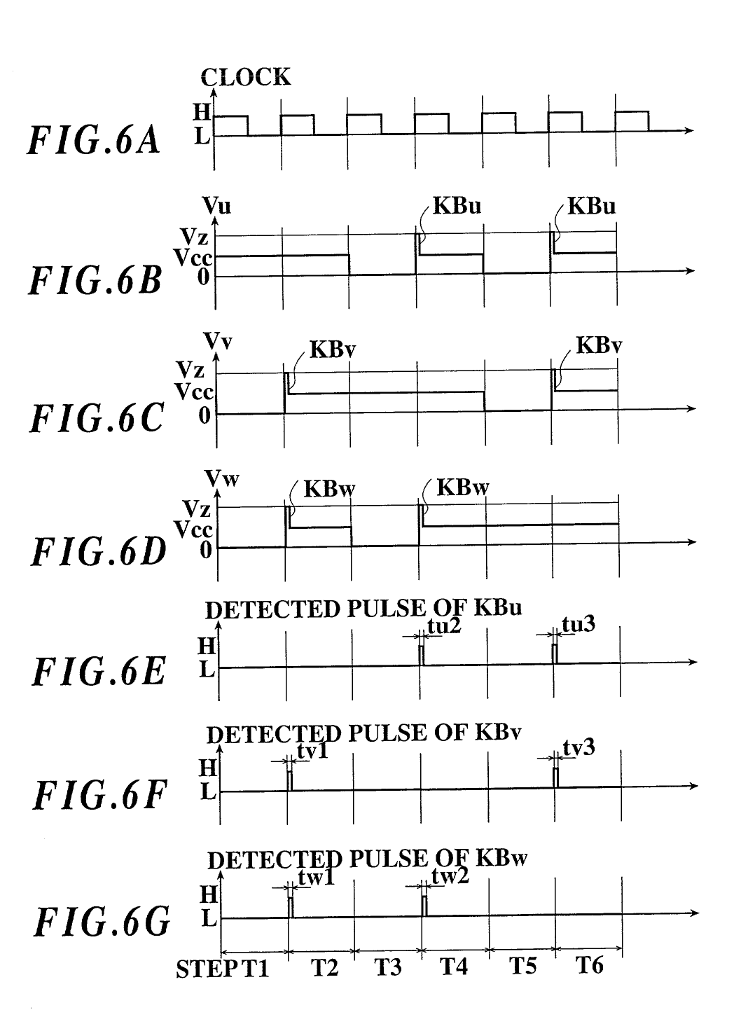

FIGS. 6A to 6G are exemplary timing charts of detecting the stop position of the rotor.

FIG. 6A is a timing chart of the clock signal, FIG. 6B is a timing chart of the U-phase output voltage, FIG. 6C is a timing chart of the V-phase output voltage, FIG. 6D is a timing chart of the W-phase output voltage, FIG. 6E is a timing chart of a detected pulse of the U-phase kickback, FIG. 6F is a timing chart of a detected pulse of the V-phase kickback, and FIG. 6G is a timing chart of a detected pulse of the W-phase kickback.

After the output transistors Q2 and Q3 are turned on in Step T1, they are turned off in Step T2. Therefore, because the kickback voltage KBv and the kickback voltage KBw are generated in the V-phase output and the W-phase output, respectively, it is determined which of the time tv1 of the detected pulse of the kickback voltage KBv and the time tw1 of the detected pulse of the kickback voltage KBw is longer.

Then, after the output transistors Q1 and Q3 are turned on in Step T3, they are turned off in Step T4. Therefore, because the kickback voltage KBu and the kickback voltage KBw are generated in the U-phase output and the W-phase output, respectively, it is determined which of the time tu2 of the detected pulse of the kickback voltage KBu and the time tw2 of the detected pulse of the kickback voltage KBw is longer.

Thereafter, after the output transistors Q1 and Q2 are turned on in Step T5, they are turned off in Step T6. Therefore, because the kickback voltage KBu and the kickback voltage KBv are generated in the U-phase output and the V-phase output, respectively, it is determined which of the time tu3 of the detected pulse of the kickback voltage KBu and the time tv3 of the detected pulse of the kickback voltage KBv is longer.

Accordingly, it is possible to determine the stop position of the rotor for every electric angle of 60 degrees on the basis of results obtained by comparing the times of detected pulses at three times.

In the controlling system of detecting the back electromagnetic force of the stator winding rotating and changing the current-carrying phase, because the output transistors Q1 to Q3 are turned on and off, the kickback voltage is generated at each phase stator winding. Therefore, if the back electromagnetic force detector detects the above-described kickback voltage and outputs the detection signal to the control logic, the control logic changes the current-carrying phase by mistake. Accordingly, it is necessary to prevent the back electromagnetic force detector from detecting the kickback voltage. As a result, in the circuit shown in FIG. 2, a mask signal is supplied from the control logic 14 to the back-EMF detector 13.

To detect the kickback voltage, three comparators each of which comprises two input terminals are provided in the circuit. In each comparator, the voltage of the output terminal of any one phase stator winding is inputted to one of two input terminals thereof, and a voltage “(Vcc+Vz)/2” which is an average of the power supply voltage Vcc and the zener voltage Vz is inputted to another of the input terminals thereof, as a reference voltage. Accordingly, when the comparator compares the voltage of the output terminal of the stator winding with the reference voltage, it is possible that the comparator outputs the detected pulse from an output terminal thereof.

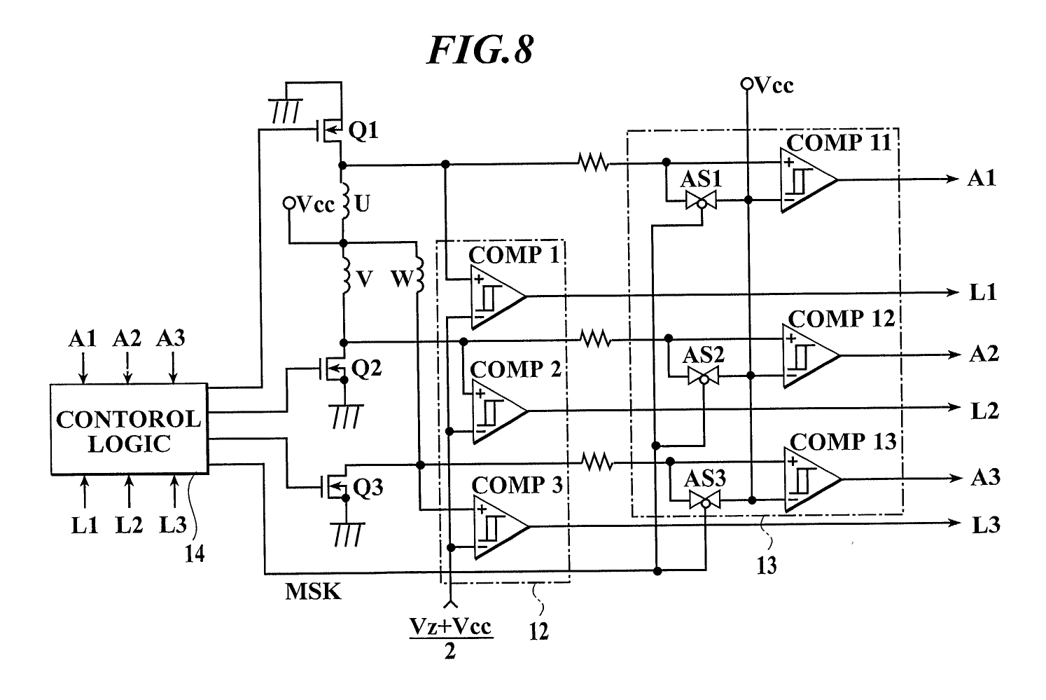

FIG. 8 is a block diagram showing a specific example of the kickback detector 12 and the back-EMF detector 13.

In FIG. 8, the reference characters “U”, “V” and “W” denote the stator windings, “Q1”, “Q2” and “Q3” denote the output transistors, “COMP1”, “COMP2” and “COMP3” denote comparators for detecting kickbacks, “COMP11”, “COMP12” and “COMP13” denote comparators for detecting back electromagnetic forces, and “AS1”, “AS2” and “AS3” denote masking analog switches. Further, the reference characters “L1”, “L2” and “L3” denote kickback detected outputs outputted from the comparators COMP1, COMP2 and COMP3 for detecting kickbacks, “A1”, “A2” and “A3” denote detected outputs outputted from the comparators COMP11, COMP12 and COMP13 for detecting back electromagnetic forces, and “MSK” denotes a mask signal supplied from the control logic 14 to the analog switches AS1, AS2 and AS3.

The threshold voltage of the comparators COMP1, COMP2 and COMP3, that is the reference voltage supplied to the inverting input terminals of the comparators COMP1, COMP2 and COMP3, is determined to be a voltage “(Vz+Vcc)/2” which is an average of the zener voltage Vz and the power supply voltage Vcc. The kickback detected outputs L1, L2 and L3 outputted from the comparators COMP1, COMP2 and COMP3 indicate “H” (High Level) while the kickback voltages are generated in the stator windings U, V and W. The threshold voltage of the comparators COMP11, COMP12 and COMP13 is determined to be a voltage “Vcc” of a center tap of the three phase stator windings. Further, the comparators COMP11, COMP12 and COMP13 having a hysteresis characteristic are used in the circuit.

Therefore, when the analog switches AS1, AS2 and AS3 are turned on, the input terminals of the comparators COMP11, COMP12 and COMP13 for detecting back electromagnetic forces keep same levels. Accordingly, while the analog switches AS1, AS2 and AS3 are on, the detected outputs A1, A2 and A3 keep states just before the analog switches AS1, AS1 and AS3 are turned on.

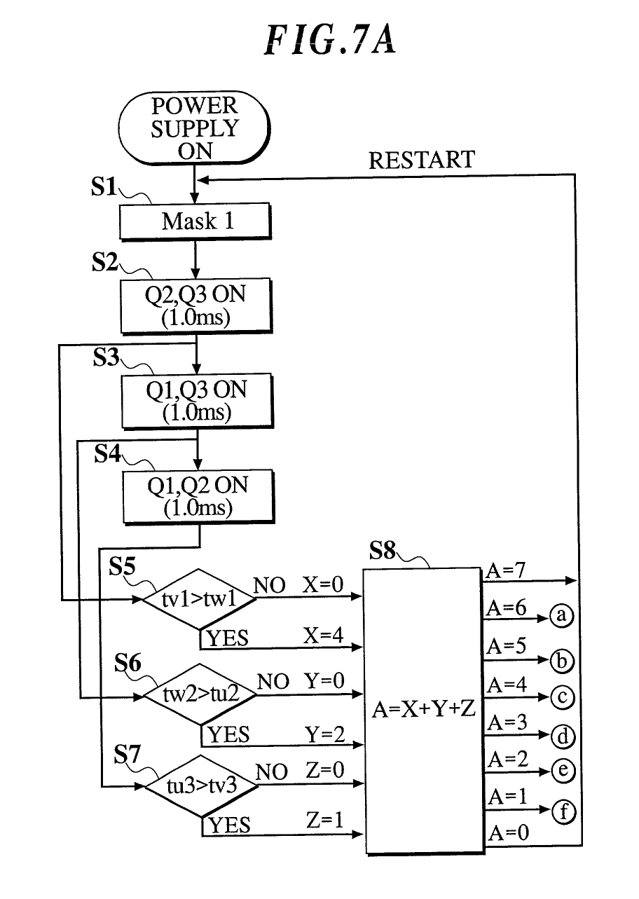

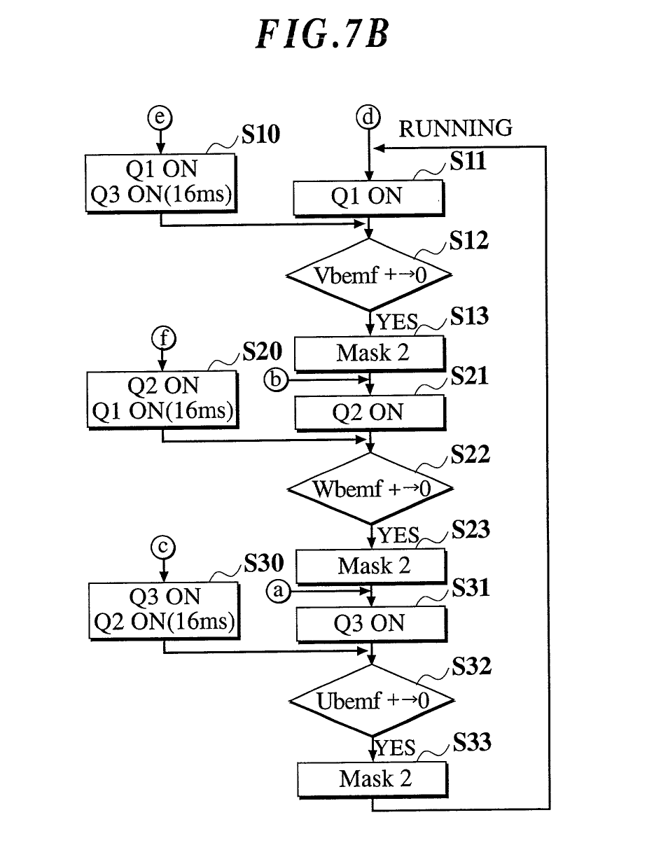

FIGS. 7A and 7B are flow charts showing a processing from detecting the stop position of the rotor to running (steady rotation) in the controlling circuit for driving the three-phase half-wave drive brushless motor to which the present invention is applied.

When the power supply is turned on, the processing is started in the circuit, according to the flow charts shown in FIGS. 7A and 7B. First, the control logic 14 determines more than ten times as long the mask signal 1 as when the motor is running, and supplies the mask signal 1 to the back-EMF detector 13 (Step S1). Then, after the output transistors Q2 and Q3 are turned on for a predetermined time (for example, 1.0 ms), they are turned off at the same time (Step S2).

Then, when the kickback detector 12 detects the kickback voltages generated in the V-phase and the W-phase, and outputs the kickback detected pulses according to the kickback times of the kickback voltages, the control logic 14 determines which of the width of the kickback detected pulse of the V-phase and the width of the kickback detected pulse of the W-phase is larger (Step S5).

When the control logic 14 determines that the width of the kickback detected pulse of the V-phase is larger than one of the W-phase, that is “tv1>tw1” (Step S5; YES), the predetermined variable X is determined to be “4”. On the other hand, when the control logic 14 determines that the width of the kickback detected pulse of the V-phase is not larger than one of the W-phase, that is “tv1<tw1” (Step S5; NO), the predetermined variable X is determined to be “0”. Thereafter, the value of the variable X is stored in a resistor temporarily.

In order to determine which one of widths of kickback detected pulses of two phases is larger than another, it is possible to use a D type flip flop in the circuit. More specifically, one of two kickback detected pulses is inputted to a data input terminal of the D type flip flop, and another is inputted to a clock terminal of the D type flip flop. Therefore, after the output transistors Q2 and Q3 are turned off, the D type flip flop latches the kickback detected pulse at the side of the data input terminal at the fall timing of the kickback detected pulse at the side of the clock terminal.

For example, in case the D type flip flop latches the kickback detected pulse of the V-phase at the fall timing of the kickback detected pulse of the W-phase, after the D type flip flop latches it, if the output of the flip flop is a low level, it means that the kickback detected pulse of the V-phase has already fallen to the low level at the fall timing of the kickback detected pulse of the W-phase. Accordingly, it is understood that the kickback detected pulse of the W-phase is larger than the kickback detected pulse of the V-phase.

On the other hand, after the D type flip flop latches it, if the output of the flip flop is a high level, it means that the kickback detected pulse of the V-phase has been at the high level yet at the fall timing of the kickback detected pulse of the W-phase. Accordingly, it is understood that the kickback detected pulse of the W-phase is smaller than the kickback detected pulse of the V-phase.

After Step S2, after the output transistors Q3 and Q1 are turned on for a predetermined time (for example, 1.0 ms), they are turned off at the same time (Step S3). Then, the control logic 14 determines which of the width of the kickback detected pulse of the W-phase and the width of the kickback detected pulse of the U-phase is larger (Step S6).

When the control logic 14 determines that the width of the kickback detected pulse of the W-phase is larger than one of the U-phase, that is “tw2>tu2” (Step S6; YES), the predetermined variable Y is determined to be “2”. On the other hand, when the control logic 14 determines that the width of the kickback detected pulse of the W-phase is not larger than one of the U-phase, that is “tw2<tu2” (Step S6; NO), the predetermined variable Y is determined to be “0”. Thereafter, the value of the variable Y is stored in the resistor temporarily.

After Step S3, after the output transistors Q1 and Q2 are turned on for a predetermined time (for example, 1.0 ms), they are turned off at the same time (Step S4). Then, the control logic 14 determines which of the width of the kickback detected pulse of the U-phase and the width of the kickback detected pulse of the V-phase is larger (Step S7).

When the control logic 14 determines that the width of the kickback detected pulse of the U-phase is larger than one of the V-phase, that is “tu3>tv3” (Step S7; YES), the predetermined variable Z is determined to be “1”. On the other hand, when the control logic 14 determines that the width of the kickback detected pulse of the U-phase is not larger than one of the V-phase, that is “tu3 <tv3” (Step S7; NO), the predetermined variable Z is determined to be “0”. Thereafter, the value of the variable Z is stored in the resistor temporarily.

Then, when the control logic 14 adds the variables X, Y and Z stored in the resistor, to get A (A=X+Y+Z), the control logic 14 determines the stop position of the rotor on the basis of “A”, and determines the current-carrying phase so as to first supply the current to the phase stator winding which can generate the biggest torque at the stop position (Step S8).

For example, in case the kickback detected pulse of the V-phase is longer than one of the W-phase (X=4), the kickback detected pulse of the W-phase is longer than one of the U-phase (Y=2), and the kickback detected pulse of the V-phase is longer than one of the U-phase (Z=0), the control logic 14 determines the current-carrying phase so as to first supply the current to the W-phase stator winding on the basis of “A” (=X+Y+Z=6). Therefore, when the processing is shifted from Step S8 in FIG. 7A to Step S31 in FIG. 7B so as to follow the arrow “a”, the current is supplied to the W-phase stator winding (Step S31). That is, the output transistor Q3 shown in FIG. 2 is turned on.

Thereafter, the back-EMF detector 13 observes the back electromagnetic force Ubemf generated in the U-phase stator winding which is a non current-carrying phase (Step S32). When the back-EMF detector 13 detects that the U-phase back electromagnetic force Ubemf crosses the zero point from the positive direction (Step S32; YES), the control logic 14 determines the mask signal 2 which is about two times as long as the kickback time when the rotor is running, and supplies the mask signal 2 to the back-EMF detector 13 (Step S33). At the same time, when the output transistor Q3 is turned off, the output transistor Q1 is turned on. Therefore, the current is supplied to the U-phase stator winding (Step S11).

Thereafter, the back-EMF detector 13 observes the back electromagnetic force Vbemf generated in the V-phase stator winding which is non current-carrying phase newly (Step S12). When the back-EMF detector 13 detects that the V-phase back electromagnetic force Vbemf crosses the zero point from the positive direction (Step S12; YES), the control logic 14 again determines the mask signal 2, and supplies the mask signal 2 to the back-EMF detector 13 (Step S13). At the same time, when the output transistor Q1 is turned off, the output transistor Q2 is turned on. Therefore, the current is supplied to the V-phase stator winding (Step S21).

As described above, every when the back-EMF detector 13 detects that the back electromagnetic force of the non current-carrying phase crosses the zero point, the phase is changed. As a result, it is possible to keep the rotor rotating.

In Step S8, when the “A” is equal to “5”, the processing is shifted to Step S21 in FIG. 7B so as to follow the arrow “b”, to start supplying the current to the V-phase stator winding. Further, when the “A” is equal to “3”, the processing is shifted to Step S11 in FIG. 7B so as to follow the arrow “d”, to start supplying the current to the U-phase stator winding.

Accordingly, because the current is first supplied to the phase which can generate the biggest torque, it is possible to drive and rotate the rotor quickly.

In Step S8, when the “A” is equal to “4”, the current-carrying is started from the W-phase stator winding as well as the case the “A” is equal to “6”. However, in order to increase the driving torque, the processing is shifted to Step S30 in FIG. 7B so as to follow the arrow “c”. Therefore, the output transistor Q3 is turned on, and the output transistor Q2 is also turned on for a predetermined time such as 16 ms at the same time. Thereafter, the processing is shifted to and started from Step S32.

The predetermined time is determined according to the characteristic driving torque and the characteristic inertial of the motor.

For example, in case of the cycle T2 shown in FIG. 5, while the rotor is usually rotated, the current is supplied to the W-phase stator winding. When the rotor is driven, in case the rotor is in a position corresponding to the latter half of the cycle T2, it is no problem that the current is supplied to only the W-phase stator winding, because the torque constant of the W-phase stator winding is not “0” substantially. However, in case the rotor is in a position corresponding to the first half of the cycle T2, it is understood that the sufficient torque cannot be generated by the W-phase stator winding even if the current is supplied to the W-phase stator winding, because the torque constant of the W-phase stator winding is “0” substantially.

Therefore, according to the embodiment, in the case the rotor is in the position wherein the sufficient torque cannot be generated, the output transistor Q2 is turned on for the predetermined time at the same time as the output transistor Q3. Accordingly, the current is supplied to not only the W-phase stator winding but also the V-phase stator winding. As a result, because the bigger torque is generated than the case the current is supplied to only the W-phase stator winding, it is possible to drive and rotate the rotor quickly.

In Step S8, when the “A” is equal to “2”, the current-carrying is started from the U-phase stator winding as well as the case the “A” is equal to “3”. However, in order to increase the driving torque, the processing is shifted to Step S10 in FIG. 7B so as to follow the arrow “e”. Therefore, the output transistor Q1 is turned on, and the output transistor Q3 is also turned on for a predetermined time such as 16 ms at the same time. Thereafter, the processing is shifted to and started from Step S12.

Further, when the “A” is equal to “1”, the current-carrying is started from the V-phase stator winding as well as the case the “A” is equal to “5”. However, in order to increase the driving torque, the processing is shifted to Step S20 in FIG. 7B so as to follow the arrow “f”. Therefore, the output transistor Q2 is turned on, and the output transistor Q1 is also turned on for a predetermined time such as 16 ms at the same time. Thereafter, the processing is shifted to and started from Step S22.

Accordingly, because the biggest current is generated in each position, it is possible to drive and rotate the rotor quickly.

In case “X=0”, “Y=0” and “Z=0”, that is “tv1<tw1”, “tw2<tu2” and “tu3<tv3”, the “A” is equal to “0” in Step S8. Furthermore, in case “X=4”, “Y=2” and “Z=1”, that is “tv1>tw1”, “tw2>tu2” and “tu3>tv3”, the “A” is equal to “7” in Step S8. However, if the kickback voltage is detected correctly, there do not occur the above cases. Therefore, according to the present embodiment, in case the “A” is equal to “0” or “7” in Step S8, because it is determined that the stop position of the rotor is not detected correctly, the processing of detecting the stop position of the rotor is shifted to Step S1 and restarted again. Herein, because the necessary time to restart the processing is within 10 ms, it is possible to disregard the effect on the driving time.

Herein, the operation and the determination in Step S8 can be performed by the control logic 14 as a software according to a program, or by a decoder so as to be branched according to outputs thereof.

Although the present invention has been explained according to the above-described embodiment, it should also be understood that the present invention is not limited to the embodiment and various chanted and modifications may be made to the invention without departing from the gist thereof.

According to the present invention, the following effects will be indicated.

The circuit of the present invention detects the stop position of the rotor on the basis of the kickback voltage. Therefore, as shown in FIGS. 6A to 6G, because the kickback voltage is sufficiently big, that is, the substantially same voltage as the power supply voltage, it is not extremely easy that the kickback voltage is affected by a noise and so on. Accordingly, there is a extremely base possibility to detect the stop position of the rotor by mistake. Further, because the kickback times of two phases which have been turned on and after tuned off at the same time, are compared with each other, it is possible to detect the accurate stop position of the rotor to the stator in the simple structure requiring no circuit as a counter, an AD converter and so on. Furthermore, because the position of the rotor to the stator can be detected exactly without using a hall element, and the winding from which the current-carrying is started can be determined, it is possible to realize the three-phase half-wave drive brushless motor which can correctly rotate in a desired direction without causing a back motion when starting rotating.

The entire disclosure of Japanese Patent Application No. Tokugan 2001-148615 filed on May 18, 2001 including specification, claims, drawings and summary are incorporated herein by reference in its entirety.

What is claimed is:

1. A n apparatus for driving a three-phase half-wave drive brushless motor comprising a rotor and three phase stator windings having a terminal connected to a power supply voltage terminal, by changing a current supplied to each of the phase stator windings, the apparatus comprising:
an output circuit for supplying the current to each of the phase stator windings selectively;
a back electromagnetic force detector for detecting a back electromagnetic force induced in one to which the current is not supplied of the phase stator windings, and outputting a detection signal;
a control logic for controlling the output circuit on the basis of the detection signal outputted from the back electromagnetic force detector; and
a stop position detector for comparing widths of kickback voltages generated in the phase stator windings with each other, after the current is supplied to each of the phase stator windings for a predetermined time while the rotor does not react and tuned off, and detecting a stop position of the rotor;
wherein the control logic controls the output circuit so as to supply the current to any one of the phase stator windings on the basis of the stop position of the rotor detected by the stop position detector, to drive the three-phase half-wave drive brushless motor.

2. The apparatus for driving the three-phase half-wave drive brushless motor, as claimed in claim 1,
wherein the control logic controls the output circuit so as to supply the current to any two phase stator windings of the three phase stator windings at the same time for a predetermined time, and
the stop position detector detects the stop position of the rotor on the basis of a time difference of kickback voltages generated in the two phase stator windings to which the current is supplied, after the current is cut off.

3. The apparatus for driving the three-phase half-wave drive brushless motor, as claimed in claim Z,
wherein the stop position detector detects the stop position of the rotor on the basis of the time difference of kickback voltages generated in each of different combinations of the two phase stator windings to which the current is supplied for the predetermined time, after the current is cut off.

4. The apparatus for driving the three-phase half-wave drive brushless motor, as claimed in claim 1,
wherein the predetermined time is longer than a time constant of each of the phase stator windings, and shorter than a reaction time of the rotor.

5. The apparatus for driving the three-phase half-wave drive brushless motor, as claimed in claim 2,
wherein the predetermined time is longer than a time constant of each of the phase stator windings, and shorter than a reaction time of the rotor.

6. The apparatus for driving the three-phase half-wave drive brushless motor, as claimed in claim 1,
wherein the control logic controls the output circuit so as to supply the current to any two phase stator windings of the three phase stator windings for a predetermined time while the rotor dose not react,
the stop position detector compares widths of kickback voltages generated in the two phase stator windings with each other, and detecting the stop position of the rotor, and
the control circuit determines any only one phase stator winding of the three phase stator windings to be a first current-carrying phase stator winding, when determining that the rotor stops within a range of an electric angle at which the only one phase stator winding has any one of a negative torque constant and a positive torque constant on the basis of the stop position of the rotor, and any two phase stator windings of the three phase stator windings to be first current-carrying phase stator windings so that a first current-carrying time of one of the two phase stator windings is shorter than a second current-carrying time of another of the two phase stator windings, when determining that the rotor stops within a range of an electric angle at which each of the two phase stator windings has the one of the negative torque constant and the positive torque constant on the basis of the stop position of the rotor.

7. The apparatus for driving the three-phase half-wave drive brushless motor, as claimed in claim 6,
wherein the first current-carrying time is 1/4-1/2 of a time required for the rotor to steadily rotate at the electric angle of 60 degrees.
